(19) United States
(12) Patent Application Publication
(10) Pub. No.: US 2014/0044303 A1
(43) Pub. Date: Feb. 13, 2014

(54) Method of Securely Scanning a Payment Card

(71) Applicant: Lexmark International, Inc., Lexington, KY (US)

(72) Inventor: Ranajyoti Chakraborti, Kolkata (IN)

(73) Assignee: Lexmark International, Inc., Lexington, KY (US)

(21) Appl. No.: 13/899,678

(22) Filed: May 22, 2013

Related U.S. Application Data
(60) Provisional application No. 61/681,652, filed on Aug. 10, 2012.

(51) Int. Cl. G06T 7/00

(52) U.S. Cl. CPC G06T 7/0002
USPC 382/100

(57) ABSTRACT

A method of securely scanning a payment card according to one example embodiment includes receiving an electronic image, determining by a processing device whether the received electronic image includes an image of a payment card, and if the received electronic image includes an image of a payment card, electronically masking at least a portion of a card number in the image of the payment card.

### CROSS REFERENCES TO RELATED APPLICATIONS

This application claims priority to U.S. Provisional Patent Application Ser. No. 61/681,652, filed Aug. 10, 2012, entitled “Method of Securely Scanning a Payment Card,” the content of which is hereby incorporated by reference in its entirety.

### BACKGROUND

1. Field of the Disclosure

The present disclosure relates generally to scanning secure documents and more particularly to securely scanning a payment card.

2. Description of the Related Art

Credit card fraud can occur if a user is able to perform unauthorized scanning of a credit card to obtain a digital record of sensitive information such as the credit card number and/or the card verification value (CVV) of the credit card being scanned. When credit card numbers and card verification values are captured by malicious users, theft and fraud may be committed using the credit card information where unauthorized funds may be acquired from an account or products may be obtained without paying. The stolen credit card information may also be used to commit identify theft.

Existing solutions for protecting scanned credit cards from identity theft and credit card fraud include using specially designed transparent envelopes that mask the card number and the CVV. Another existing solution includes placing stickers on portions of the card containing the CVV and the card number to mask these numbers prior to scanning. However, these solutions are labor intensive and rely entirely on the operator of the scanning device. Accordingly, there is a need for an efficient method of securely scanning a credit card to protect sensitive information.

### SUMMARY

A method of securely scanning a payment card according to one example embodiment includes receiving an electronic image, determining by a processing device whether the received electronic image includes an image of a payment card, and if the received electronic image includes an image of a payment card, electronically masking at least a portion of a card number in the image of the payment card.

A method of securely scanning a payment card according to another example embodiment includes receiving a first electronic image and comparing a size of the first electronic image with a predetermined card size. If the size of the first electronic image corresponds to the predetermined card size, it is determined that the received electronic image includes an image of a first side of a payment card. At least a portion of a first card number in the image of the first side of the payment card is electronically masked. A determination is made whether a second electronic image including an image of a second side of the payment card has been received. If a second electronic image including an image of a second side of the payment card has been received, at least a portion of a second card number in the image of the second side of the payment card is electronically masked.

### BRIEF DESCRIPTION OF THE DRAWINGS

The above-mentioned and other features and advantages of the present disclosure, and the manner of attaining them, will become more apparent and will be better understood by reference to the following description of example embodiments taken in conjunction with the accompanying drawings. Like reference numerals are used to indicate like elements throughout the specification.

FIG. 1 is a flowchart illustrating a method for securely scanning a payment card according to one example embodiment.

FIG. 2A is an example scanned image of a front side of a payment card.

FIG. 2B is an example image of the front side of the payment card shown in FIG. 2A with a portion of a card number masked.

FIG. 3A is an example scanned image of a back side of a payment card.

FIG. 3B is an example of the back side of the payment card shown in FIG. 3A with a portion of a card number and a card verification value masked.

### DETAILED DESCRIPTION

It is to be understood that the disclosure is not limited to the details of construction and the arrangement of components set forth in the following description or illustrated in the drawings. The disclosure is capable of other embodiments and of being practiced or carried out in various ways. For example, other embodiments may incorporate structural, chronological, process and other changes. Examples merely typify possible variations. Individual components and functions are optional unless explicitly required and the sequence of operations may vary. Portions and features of some example embodiments may be included in or substituted for those of others. The scope of the application encompasses the appended claims and all available equivalents. The following description is, therefore, not to be taken in a limited sense and the scope of the present disclosure is defined by the appended claims.

Also, it is to be understood that the phraseology and terminology used herein is for the purpose of description and should not be regarded as limiting. The use of “including,” “comprising,” or “having” and variations thereof is meant to encompass the items listed thereafter and equivalents thereof as well as additional items. Unless limited otherwise, the terms “connected,” “coupled,” “mounted,” and variations thereof herein are used broadly and encompass direct and indirect connections, couplings and mountings. In addition, the terms “connected” and “coupled” and variations thereof are not restricted to physical or mechanical connections or couplings. Further, the terms “a” and “an” herein do not denote a limitation of quantity, but rather denote the presence of at least one of the referenced item.

In addition, it should be understood that embodiments of the disclosure include both hardware and electronic components or modules that, for purposes of discussion, may be illustrated and described as if the majority of the components were implemented solely in hardware.

It will be further understood that each block of the diagrams and combinations of blocks in the diagrams, respectively, may be implemented by computer program instructions. These computer program instructions may be loaded onto a general purpose computer, special purpose computer or other programmable data processing device to produce a machine, such that the instructions which execute on the computer or other programmable data processing device may create means for implementing the functionality of each block or combinations of blocks in the diagrams discussed in detail in the descriptions below.

These computer program instructions may also be stored in a non-transitory computer-readable medium that may direct a computer or other programmable data processing device to function in a particular manner, such that the instructions stored in the computer-readable medium may produce an article of manufacture including an instruction means that implements the function specified in the block or blocks. The computer program instructions may also be loaded onto a computer or other programmable data processing device to cause a series of operational steps to be performed on the computer or other programmable apparatus to produce a computer implemented process such that the instructions that execute on the computer or other programmable apparatus implement the functions specified in the block or blocks. Output of the computer program instructions, such as the process models and the combined process models, as will be described in greater detail below, may be displayed in a user interface or computer display of the computer or programmable apparatus that implement the functions or the computer program instructions.

The methods disclosed may be computer program instructions executed by a processor of a computing device such as, for example, a scanning device or a multi-function printer. The scanning device may also be any form of image-capturing device that may execute a function such as, for example but not limited to, cameras, photocopiers, fax machines or any device that includes a processor and a computer-readable medium, such as a random access memory (RAM), coupled to the processor. The processor may execute computer-executable program instructions stored in the memory.

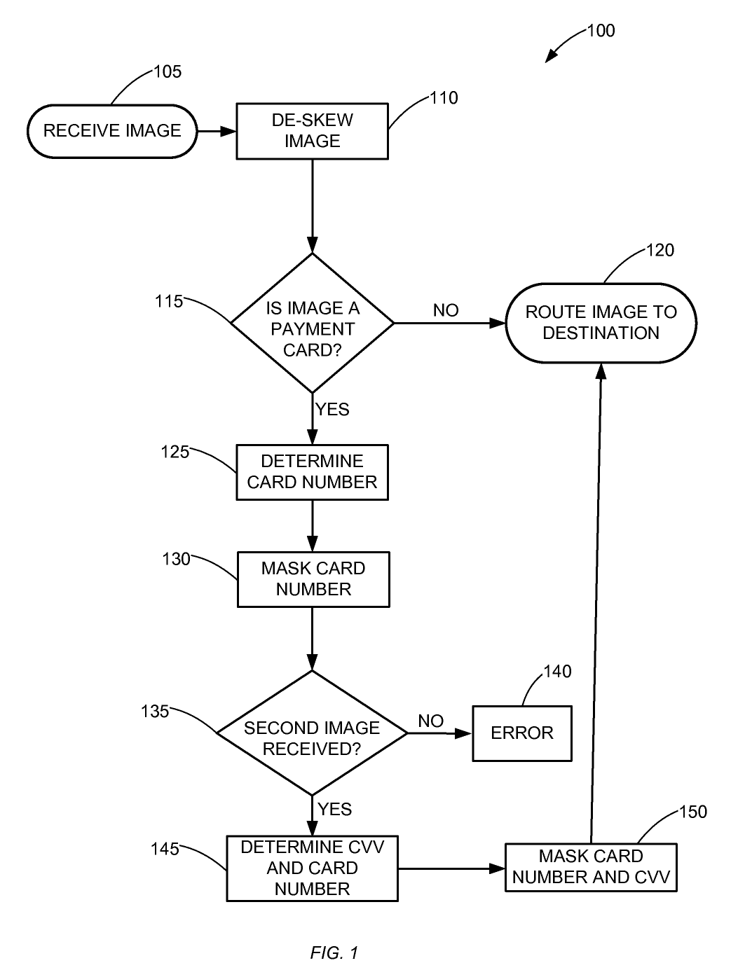

FIG. 1 is a flowchart illustrating a method 100 for securely scanning a payment card according to one example embodiment. Method 100 may include, for example, scanning the payment card to generate an electronic image of the payment card, de-skewing the scanned image, determining an image size of the payment card in the scanned image, electronically masking portions of the scanned image containing sensitive information and electronically routing the scanned image to a destination.

At block 105, an image is received electronically. Receiving the image may include receiving the image from a scanning unit of, for example, a standalone document scanner or a multi-function printer. In another example embodiment, receiving the image may include receiving the image from an image-capturing device such as, for example, a camera such as a standalone camera or a smartphone camera. In an alternative example embodiment, the image may be received from a computing device.

At block 110, the scanned image received may be de-skewed as desired. Scanned images may be skewed or slanted during image capture by the scanning unit due to factors such as errors in alignment or mis-feeds of the item being scanned. Skew refers to an amount of rotation that may occur in an image during capture and de-skewing may be a process by which the image is rotated by substantially the same amount as its skew but in the opposite direction thereby returning the image to a substantially vertically and/or horizontally aligned orientation. The scanned image may be de-skewed to improve readability of the image. For example, a de-skewed image may be vertically and horizontally aligned and text in the image may run substantially horizontally across the document rather than at an angle. De-skewing is performed electronically using one or more de-skewing algorithms known in the art.

At block 115, a determination is made by the processing device whether the received image includes an image of a payment card. For example, the received image may include an image of a front side or a back side of a payment card. A payment card may be, for example, a credit card or a debit card that may be used by a cardholder for making a payment. Payment cards may be electronically linked to one or more bank or credit accounts of the cardholder. Payment cards may also be a charge card, a stored-value card, a fleet card or other types of cards that may be used for payment as will be known by one of ordinary skill in the art.

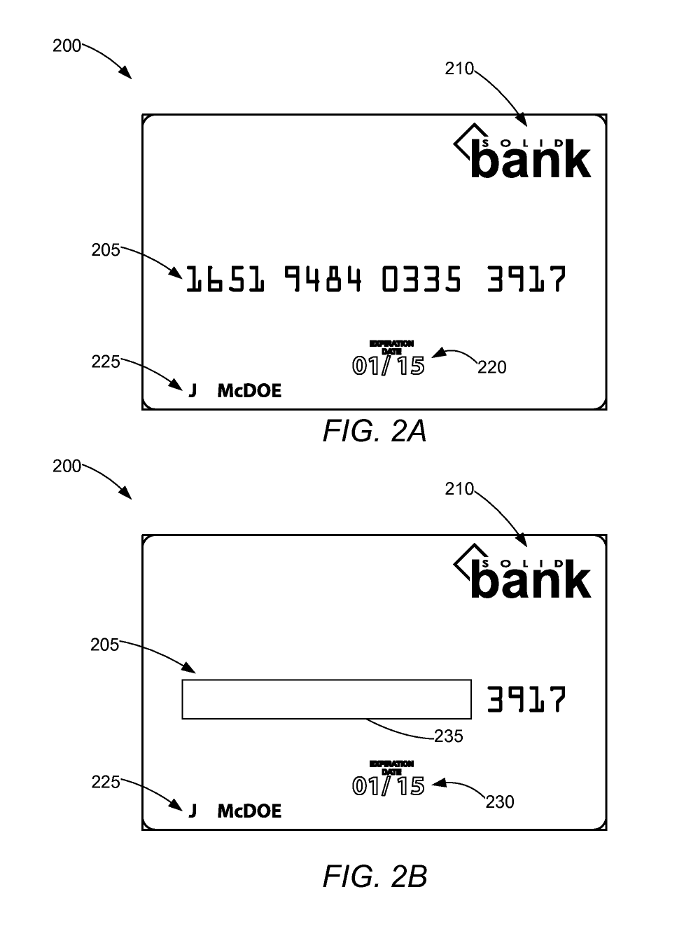

The received image may include an image of a front side of a payment card. For instance, FIG. 2A is an example of a scanned image of a front side 200 of a payment card. Front side 200 of the payment card may include a card number 205, an issuing bank logo 210, an expiration date 220 and the cardholder's name 225. It will be appreciated by one of ordinary skill in the art that other information may be included on the payment card such as a hologram, a card brand logo, a date of membership or a CVV among many others.

Card number 205 may be embossed on the payment card and elevated from the surface of front side 200 of the payment card. The embossment of card number 205 on front side 200 of the payment card may provide a corresponding recessed shape on a back side of the payment card as will be described below. The embossed card number 205 may be painted with a high intensity color that may distinguish card number 205 from a background color of front side 200 of the payment card.

In one embodiment, determining whether the received image includes an image of a payment card includes determining a size of the image and comparing the size of the image with a predetermined size of a payment card. Determining the size of the image may include determining a size of an item contained within the overall image that may be an image of a payment card such as where an image of a payment card is included in the received image but does not take up the entire area of the received image. For example, boundary detection techniques known in the art may be performed to identify a payment card in the image. Boundary detection may refer to one or more methods of detecting contours or edges in order to determine the actual size of the item in the scanned image that may correspond to the payment card. Once the size of the item in the scanned image is determined, it may be compared with a predetermined size of a payment card to determine whether the item in the scanned image is a payment card.

The predetermined size may be a standard size of payment cards. For example, ISO/IEC 7810 Identification cards—Physical Characters is an international standard that specifies the physical characteristics of identification cards including dimensions of cards, including payment cards. The standard specifies the dimensions of ID cards and most banking cards, including payment cards such as credit cards and debit cards. The ID-1 format of the standard specifies a size of 85.60×53.98 mm (3.370×2.125 in) and rounded corners with a radius of 2.88-3.48 mm, which is commonly used for banking cards including payment cards. In one embodiment, the dimensions specified by ID-1 format of the ISO/IEC 7810 are used as the predetermined size of a payment card by which the determined size of the scanned image is compared against.

Determining the size of the scanned image may be performed to evaluate whether or not the scanned image is a payment card. In one example embodiment, one or more additional or substitute factors may also be used to evaluate whether or not the scanned image is a payment card. These factors include, but are not limited to, whether the image was created by scanning performed by an automatic document feeder of a scanning device (where scanning by an automatic document feeder indicates that the scanned image is not an image of a payment card), whether a card number is present on at least one side of the image, whether a card number is located approximately at the same location as an industry standard, whether card numbers are elevated and/or painted with a high intensity color, whether a black band is present across the scanned image at a fixed height in accordance with an industry standard. The black band may refer to a magnetic stripe. In alternative example embodiments, magnetic stripes may come in other colors such as, for example, brown and silver. The magnetic stripe may identify the scanned image as a form of payment card that may be capable of storing information through a band of magnetic material on the card. These parameters may be used as additional evaluation criteria for determining whether the scanned image is a payment card. It will be known in the art that the aforementioned parameters are merely examples of the criteria that may be used to determine whether the received image is an image of a payment card that other suitable parameters may be used in addition to or in place of these parameters. Similarly, all or less than all of the listed parameters may be used as desired and these parameters may be combined with other suitable parameters.

If it is determined that the received image does not include an image of a payment card, the received image is electronically routed to the destination at block 120. The destination may be a predetermined destination to which the scanned image may be transmitted after scanning. For example, the destination may be a client device connected to the scanning unit. In one example, the destination may be set by the user of the scanning device prior to scanning the payment card.

If the received image is determined to include an image of a payment card, a card number may be identified in the image by the processing device at block 125. Identifying the card number in the scanned image may be performed on the scanned image corresponding to front side 200 of the payment card. Front side 200 of the payment card may be detected by identifying whether or not the black band or the magnetic stripe, as described above, is present on the image. If the black band is absent from the scanned image, the scanned image may correspond to front side 200 of the payment card. Alternately, if the black band is present in the scanned image, the scanned image may correspond to a back side of the payment card. In the example embodiment illustrated, the scanned image received at block 105 and analyzed at block 125 corresponds to front side 200 of the payment card.

A card number may refer to a sixteen digit number that includes an issuer identifier and an account number. In this example embodiment, the card number may be a sixteen-digit number displayed on front side 200 of the payment card. It will be appreciated that the card number may be any length other than the aforementioned. According to one industry standard, the first digit or two digits indicate the card system (e.g., travel/entertainment cards, Visa, MasterCard, Discover, etc.). Other digits, for example digits two through six, indicate a bank number. Additional digits, for example digits seven through fifteen, indicate an account number and may correspond to the account identifier of the cardholder of the payment card. One of the digits, such as the last digit, may include a check digit. The check digit may be a single digit that is calculated from the other digits in the card number. The check digit may be derived using one or more algorithms such as the Luhn algorithm, which computes the check digit to confirm the initial digits of the payment card.

The card number may be identified by performing optical character recognition (OCR) on the scanned image and identifying a number that corresponds to the card number as described above. In an alternative example embodiment, identifying the card number may be performed by generating connected components corresponding to the scanned image and extracting image features of the scanned image. Other methods for identifying the card number may include performing edge detection algorithms for feature detection and subsequent identification of image features from the scanned image which may correspond to the card number. In an alternative example embodiment, identifying the card number may be performed using histogram-related mechanisms to find a percentage of pixels having a certain pixel intensity that is substantially different from a background of the card in the scanned image.

At block 130, at least a portion of card number 205 in the image is electronically masked. The determined card number 205 may be masked fully thereby covering all of the digits determined at block 125. Alternatively, card number 205 may be partially masked based on one or more predetermined requirements. For example, some credit card associations require merchants to display only the last four digits of the card number. Thus, for credit cards under these associations, all the digits except the last four digits of the credit card number are concealed through masking the portion of the card number containing the digits other than the last four digits. It will be appreciated that other payment card associations may require other combinations of digits to be concealed. In one embodiment, the digits of the card number to be masked may be set by a user of the scanning device. In an alternative example embodiment, the digits of the card number to be masked may be pre-set in the scanning device.

FIG. 2B shows the image of front side 200 of the payment card shown in FIG. 2A with the first twelve digits of card number 205 masked using a layer 235 to conceal card number 205. Masking card number 205 may be performed through image modification of the scanned image corresponding to the payment card by electronically applying layer 235 having approximately the same area as the portion of card number 205 to be masked over the portion of the scanned image of front side 200 that contains card number 205.

Identifying the portion that contains card number 205 in the scanned image may include automatically approximating a location of the card number using one or more of the methods of identifying the card number such as, for example, optical character recognition or histogram-related mechanisms as are known in the art. After the portion that contains card number 205 is identified, layer 235 may be placed over the image of card number 205 to conceal a desired portion of card number 205 in the scanned image.

In an alternative example embodiment, the user of the scanning device may perform the identification of the portion that contains card number 205 in the scanned image and mask the desired portion using one or more user enabled functions included in the scanning device.

At block 135, a determination may be made by the processing device whether a second image has been electronically received from the scanning unit. In this example embodiment, the second image is the back side of the payment card. It will be appreciated that in alternative example embodiments, the first image received at block 105 may be the back side of the payment card while the second image at block 135 may be the front side of the payment card. If a second image is not received from the scanning unit, an error message may be displayed on the scanning device (at block 140). In alternative example embodiments, the error message may be displayed on the MFP or the image-capturing device that is used to receive the first scanned image or no error message may be triggered and instead the masked image of the image received at block 105 may be routed to its destination at block 120.

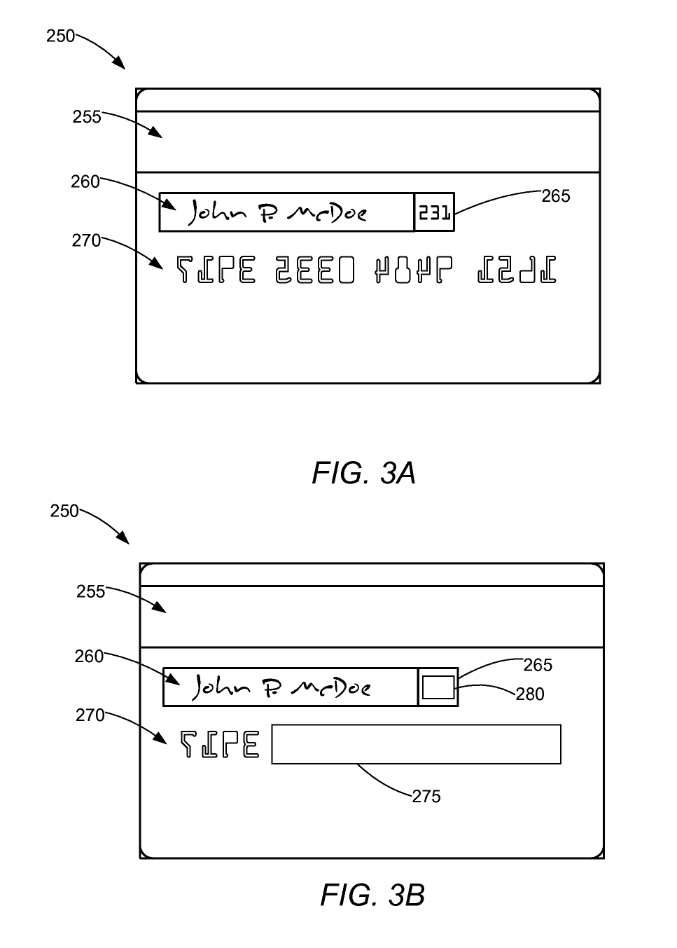

If a second image is received, in one embodiment, the second image may be de-skewed similar to block 110 discussed above. FIG. 3A is an example of a scanned image of a back side 250 of the payment card. Back side 250 includes a magnetic stripe 255, a signature strip 260 with an accompanying signature of the cardholder, a CVV box containing CVV 265, the card number 270 that may correspond to card number 205 on front side 200 of the payment card. Card number 270 may be formed due to the embossed card number 205 in front side 200 of the payment card as discussed above. CVV 265 may be a three-digit card verification value code. CVV 265 may be used to provide an additional security measure against unauthorized use of the payment card or against credit card fraud.

Back side 250 of the payment card may be scanned in order to provide more information regarding the payment card and/or the cardholder. If a second image is received from the scanning unit, CVV 265 and card number 270 may be electronically searched on back side 250 of the second scanned image (at block 145).

CVV detection may be performed by judging an intensity of adjacent pixels. In an alternative example embodiment, detecting CVV 265 may be performed using boundary detection. Other methods may include optical character recognition and approximating a location of CVV 265 relative to magnetic stripe 255. Detection of magnetic stripe 255 may be performed using boundary detection techniques known in the art.

Detection of card number 270 may be performed using optical character recognition or histogram-related mechanisms. In alternative example embodiments, location of card number 270 may be automatically approximated using the location of card number 205 on front side 200. In other example embodiments, card number 270 and CVV 265 may be determined by a user of scanning device using one or more functions in the device.

Once CVV 265 and card number 270 are identified in the second scanned image, card number 270 (or a portion thereof) and CVV 265 may be electronically masked (at block 150). For example, FIG. 3B shows the image of back side 250 of the payment card shown in FIG. 3A with card number 270 masked by a card number layer 275 and CVV 265 masked by a CVV layer 280.

Masking the card number may be performed through image modification of the scanned image corresponding to the payment card wherein layer 275 having approximately the same area as card number 270 may be applied and placed over the portion of back side 250 that contains card number 270 in the scanned image. Similarly, layer 280 may have approximately the same area as CVV 265 and be placed over the portion of back side 250 that contains CVV 265 in the scanned image.

Once CVV 265 and card number 270 are masked and concealed on the scanned image of back side 250 and card number 205 is masked and concealed on the scanned image of front side 200, the scanned images corresponding to front side 200 and back side 250 of the payment card may be routed to the destination as set by the user of the scanning device (at block 120) or as pre-set in the scanning device. The destination of the scanned images may be requested by the user of the scanning device prior to scanning the images.

It will be appreciated that the actions described and shown in the example flowcharts may be carried out or performed in any suitable order. It will also be appreciated that not all of the actions described in FIG. 1 need to be performed in accordance with the embodiments of the disclosure and/or additional actions may be performed in accordance with other embodiments of the disclosure.

Many modifications and other embodiments of the disclosure set forth herein will come to mind to one skilled in the art to which these disclosure pertain having the benefit of the teachings presented in the foregoing descriptions and the associated drawings. Therefore, it is to be understood that the disclosure is not to be limited to the specific embodiments disclosed and that modifications and other embodiments are intended to be included within the scope of the appended claims. Although specific terms are employed herein, they are used in a generic and descriptive sense only and not for purposes of limitation.

1. A method of securely scanning a payment card, comprising:
receiving an electronic image;
determining by a processing device whether the received electronic image includes an image of a payment card; and
if the received electronic image includes an image of a payment card, electronically masking at least a portion of a card number in the image of the payment card.

2. The method of claim 1, wherein determining whether the received electronic image includes an image of a payment card includes comparing a size of the received electronic image with a predetermined card size and determining that the received electronic image includes an image of a payment card if the size of the received electronic image corresponds to the predetermined card size.

3. The method of claim 1, further comprising de-skewing the received electronic image prior to determining whether the received electronic image includes an image of a payment card.

4. The method of claim 1, further comprising electronically sending the received electronic image having at least a portion of the card number masked to a destination.

5. The method of claim 4, further comprising if the received electronic image does not include an image of a payment card, electronically sending the received electronic image to the destination.

6. The method of claim 1, wherein determining whether the received electronic image includes an image of a payment card includes determining whether a card number is present and located substantially at a predetermined location.

7. The method of claim 1, wherein determining whether the received electronic image includes an image of a payment card includes determining whether a solid band is present at substantially a predetermined height.

8. The method of claim 1, wherein the received electronic image includes a scanned image of a front side of a payment card and further comprising receiving a second electronic image including a scanned image of a back side of the payment card.

9. The method of claim 8, further comprising electronically masking at least a portion of a second card number in the image of the back side of the payment card.

10. The method of claim 9, wherein electronically masking at least a portion of the second card number in the image of the back side of the payment card includes electronically masking a corresponding portion of a reverse side of the card number electronically masked in the image of the front side of the payment card.

11. The method of claim 9, wherein electronically masking at least a portion of the second card number in the image of the back side of the payment card includes electronically masking a card verification value in the image of the back side of the payment card.

12. A method of securely scanning a payment card, comprising:
receiving a first electronic image;
comparing a size of the first electronic image with a predetermined card size;
if the size of the first electronic image corresponds to the predetermined card size:
determining that the received electronic image includes an image of a first side of a payment card;
electronically masking at least a portion of a first card number in the image of the first side of the payment card;
determining whether a second electronic image including an image of a second side of the payment card has been received;
if a second electronic image including an image of a second side of the payment card has been received:
electronically masking at least a portion of a second card number in the image of the second side of the payment card.

13. The method of claim 12, wherein electronically masking at least a portion of the second card number in the image of the second side of the payment card includes electronically masking a corresponding portion of a reverse side of the first card number electronically masked in the image of the first side of the payment card.

14. The method of claim 12, wherein at least one of electronically masking at least a portion of the first card number in the image of the first side of the payment card and electronically masking at least a portion of the second card number in the image of the second side of the payment card includes electronically masking a card verification value.

15. The method of claim 12, further comprising if the size of the first electronic image does not correspond to the predetermined card size, electronically sending the first electronic image to a destination.

16. The method of claim 12, further comprising if a second electronic image including an image of a second side of the payment card has not been received, electronically sending an error message.

17. The method of claim 12, further comprising de-skewing the first electronic image prior to comparing the size of the first electronic image with the predetermined card size.

18. A computing device, comprising one or more processing devices configured to:
receive an electronic image;
determine whether the received electronic image includes an image of a payment card; and
if the received electronic image includes an image of a payment card, electronically mask at least a portion of a card number in the image of the payment card before sending the electronic image to a destination.

19. The computing device of claim 18, wherein the one or more processing devices are configured to determine whether the received electronic image includes an image of a payment card by comparing a size of the received electronic image with a predetermined card size.

20. The computing device of claim 18, wherein the one or more processing devices are configured to de-skew the received electronic image prior to determining whether the received electronic image includes an image of a payment card.
